(19) United States
(12) Patent Application Publication
(10) Pub. No.: US 2024/0276585 A1
(43) Pub. Date: Aug. 15, 2024

(54) METHODS AND NETWORK NODES FOR SUSPEND-RESUME FOR L1/L2 CENTRIC INTER-CELL MOBILITY CONFIGUATION(S)

(71) Applicant: TELEFONAKTIEBOLAGET LM ERICSSON (PUBL), Stockholm (SE)

(72) Inventors: ICARO LEONARDO DA SILVA, SOLNA (SE); PRADEEPA RAMACHANDRA, LINKÖPING (SE); HELKA-LIINA MÄÄTTÄNEN, ESPOO (SE)

(21) Appl. No.: 18/570,200

(22) PCT Filed: Jun. 17, 2022
(86) PCT No.: PCT/IB2022/055648

§ 371 Date: Dec. 14, 2023

Related U.S. Application Data
(60) Provisional application No. 63/211,882, filed on Jun. 17, 2021.

(51) Int. Cl. H04W 76/27

(52) U.S. Cl. CPC H04W 76/27

(57) ABSTRACT

There is provided a method performed by a user equipment (UE) in a Layer 1(L1)/Layer 2 (L2) centric inter-cell mobility environment or for inter-cell multi-Transmission Reception Point (mTRP) operation. The method comprises: suspending a connection based on a first configuration for L1/L2 centric inter-cell mobility or for inter-cell mTRP; receiving a resume message to resume a connection with a network node; and in response to receiving the resume message, resuming the connection with the network node, based on a second configuration for L1/L2 centric inter-cell mobility or for inter-cell mTRP operation. A method in a first network node is also provided. The method comprises transmitting a suspend message to the UE to suspend a connection with the first network node; and suspending the connection by performing one of deleting a first configuration for L1/L2 centric inter-cell mobility or for inter-cell mTRP operation and storing the first configuration.

### RELATED APPLICATIONS

This application claims the benefits of priority of U.S. Provisional Patent Application No. 63/211882, entitled “Methods and network nodes for Suspend-Resume for L1/L2 centric inter-cell mobility configuration(s)” and filed at the United States Patent and Trademark Office on Jun. 17, 2021, the content of which is incorporated herein by reference.

### TECHNICAL FIELD

This description generally relates to wireless communication systems, and particularly, to methods and nodes for suspend-Resume for L1/L2 centric inter-cell mobility configuration(s).

### BACKGROUND

### Suspend/Resume Procedure and RRC_INACTIVE

In New Radio (NR), a User Equipment (UE) in connected mode (RRC_CONNECTED) is suspended by the network and enters RRC_INACTIVE upon the reception of the RRCRelease message including a suspend configuration (suspendConfig), as illustrated in Third Generation Partnership Project (3GPP) Technical specification (TS) 38.331 v.16.4.1, for example.

When entering RRC_INACTIVE, the UE stores in the UE Inactive Access Stratum (AS) Context different parameters, such as the spCellConfigCommon within ReconfigurationWithSync of the NR Primary secondary cell (PSCell) (if configured) and all other parameters configured except for: parameters within ReconfigurationWithSync of the Primary cell (PCell), parameters within ReconfigurationWithSync of the NR PSCell, if configured; parameters within Mobility ControlInfoSCG of the E-UTRA PSCell, if configured; servingCellConfigCommonSIB. In other words, the UE stores some of the RRC configuration used in RRC_CONNECTED.

The UE may later resume the connection (either responding to paging or due to a procedure triggered by the higher layer or Radio Resource Control (RRC)) by transmitting an RRC Resume Request message to the cell the UE is camping (i.e. a cell associated to a target gNodeB). The UE then restores the stored parameters/configurations, receives an RRC Resume message, enters RRC_CONNECTED and transmits an RRC Resume Complete. This is illustrated in TS 38.300 for example.

### L1/L2 Centric Inter-Cell Mobility

In Release-17 (Rel-17), 3GPP is going to standardize what is called so far Layer1/Layer2 (L1/L2) centric inter-cell mobility (or L1-mobility, inter-Physical Cell Identity (PCI) Transmission Configuration Indicator (TCI) state change/update/modification, etc.). This is justified in the Work Item Description (WID) RP-193133 (Further enhancements on multiple input multiple output (MIMO) for NR) by the fact that while Rel-16 manages to offer some reduction in overhead and/or latency, high-speed vehicular scenarios (e.g. a UE traveling at high speed on highways) at Frequency Range 2 (FR2) require more aggressive reduction in latency and overhead—not only for intra-cell, but also for L1/L2 centric inter-cell mobility.

Even though 3GPP has not decided how a L1/L2 inter-cell centric mobility should be standardized, the understanding for the purpose of the disclosure is that the UE receives a L1/L2 signaling (instead of RRC signaling) indicating a TCI state (e.g. for Physical Downlink Control Channel (PDCCH)) possibly associated to an Synchronization Signal Block (SSB) whose PCI is not necessarily the same as the PCI of the cell the UE has connected to, e.g. via connection resume or connection establishment. In other words, in the disclosure, the L1/L2-centric inter-cell mobility procedure can be interpreted as a beam management operation expanding the coverage of multiple SSBs associated to multiple PCIs (e.g. possibly associated to the same cell or different cells).

RAN2 has initiated the work in L1/L2 centric inter-cell mobility in RAN2#104e meeting. In general terms, that includes at least two scenarios:

### Scenario 1: Inter-Cell Multi-TRP-Like Model

In this case, the UE can receive/transmit data simultaneously from multiple Transmission/Reception Points (TRP) (referred to as mTRP) which may lead to the UE monitoring control channels of more than one TRP for data reception and/or transmitting data to more than one TRP, where each of these TRPs may be associated to different cells and/or PCIs. The indication for the UE to monitor one TRP/cell or the other TRPs/cells (add, release, activation, deactivate a TRP/cell) may be done with lower layer signaling, e.g. Medium Access Control (MAC) Control Elements (CEs).

### Scenario 2: L1/L2 Mobility Model (i.e. with Serving Cell Change)

In this case, the UE can receive/transmit data from one cell/PCI at the time, where the indication for the UE to change from one cell/PCI or the other cell/PCI may be done with lower layer signalling, e.g. MAC CE(s).

### SUMMARY

There currently exist certain challenge(s). The problem to be solved is that if a feature is available for a capable UE within an area covered by a set of PCIs, the UE can rely on beam management procedures, i.e. L1 measurements/reporting and MAC CE/Downlink Control Information (DCI) indications (or any other lower layer signaling like in Radio Link Control (RLC), MAC or Physical (PHY) layers in the protocol stack), either for performing L1/L2 centric inter-cell mobility (moving from one cell/PCI to another) or for performing mTRP operation (activating multiple TRPs/cells/PCIs for data transmission/reception).

A mobility scenario is illustrated in FIG. 1, where the UE is configured with a set of PCIs, e.g., PCI-1 to PCI-4. The UE can change PCIs over different times (e.g., T1 to T5).

A mTRP scenario is illustrated in FIG. 2, where a UE can transmit to/receive from TRP(1) and TRP(2).

While the UE may be configured with a set of PCIs (which may be associated to different cells) with which it can perform L1/L2 centric inter-cell mobility (or mTRP operation, e.g. multi-PDCCH/multi-DCI), the network may determine to suspend the connection (so the UE transitions to RRC_INACTIVE). That connection is later resumed (and the UE transitions to RRC_CONNECTED).

The UE behavior regarding the L1/L2 centric inter-cell mobility (and/or mTRP) configurations have not been defined when the UE enters RRC_INACTIVE. Consequently, it is also not clear what the UE needs to do upon Resume, when transitioning to RRC_CONNECTED. The lack of clear UE behavior may lead to a state/configuration mismatch between the UE and the network (after UE AS Inactive context mismatch), which may lead to a Reconfiguration failure (which leads to re-establishment).

Even though details are not settled yet in 3GPP, the UE is going to be configured with multiple TCI state configurations, where each TCI state configuration has its Quasi-Co-Location (QCL) Reference Signal (RS), e.g. a SSB, and where different TCI state configurations may have as their QCL RSs different SSBs from different cells and/or different PCIs.

As a note, for simplicity, the term L1/L2 centric inter-cell mobility comprises either the mobility use case and/or the mTRP use case, i.e. either scenario 1 or scenario 2 in the RAN2 agreements, or both.

Certain aspects of the disclosure and their embodiments may provide solutions to these or other challenges. The embodiments comprise a method performed by the UE in a L1/L2 centric inter-cell mobility environment or for inter-cell mTRP operation. The method may comprise: suspending a connection based on a first configuration for L1/L2 centric inter-cell mobility or for inter-cell mTRP; receiving a resume message to resume a connection with a network node; and in response to receiving the resume message, resuming the connection with the network node, based on a second configuration for L1/L2 centric inter-cell mobility or for inter-cell mTRP operation.

The embodiments comprise a method performed by a first network node (it may be gNB or within a gNB, e.g. in case of mTRP operating as the serving network node for a UE). The method may comprise: transmitting a suspend message to the UE to suspend a connection with the first network node; and suspending the connection by performing one of deleting a first configuration for L1/L2 centric inter-cell mobility or for inter-cell mTRP operation and storing the first configuration

The embodiments comprise a method performed by a second network node (it may be gNB or within a gNB, e.g. in case of mTRP), operating as the target network node for a UE. The method may comprise: receiving a resume request from the UE, operating in a L1/L2 centric inter-cell mobility environment or for inter-cell mTRP; transmitting a resume message to the UE; and resuming the connection based on a configuration for L1/L2 centric inter-cell mobility or for inter-cell mTRP operation.

As a variation to the above operations where the UE performs actions per “configuration”, a UE can perform the same operation per “part of the configuration”. In L1/L2 mobility, the UE has initially received a configuration for more than one PCI. Depending on the approach, the UE may have received a standalone serving cell configuration per PCI, or the UE may have received a standalone configuration for a serving cell which includes access configuration per PCI/SSB. Now, the UE may be instructed, by specification or by signalling to treat configuration related to one SSB/PCI as one “part of configuration”. For example, the UE may have been instructed to discard configurations related to PCI-1 and PCI-3 but to store configuration related to PCI-2. This can also be viewed as the mTRP operation.

There are also provided a UE and a network node to perform respectively the methods described above.

Certain embodiments may provide one or more of the following technical advantage(s).

There will be no state/configuration mismatch between the UE and the network (or network node) when the UE tries to resume a connection. That prevents a re-configuration failure, which would lead to a failure followed by a Re-establishment procedure.

In addition, the embodiments provide a signaling reduction in the case the configuration for L1/L2 centric inter-cell mobility (and/or mTRP) can be stored upon suspending and restored upon resume. That makes sense in case the UE suspends and resumes in the same area, e.g. controlled by the same baseband, gNB, Distributed Unit (DU), so that the cell/PCI candidates remain similar, at least some of them.

Note that this is relevant as the configuration for L1/L2 centric inter-cell configuration (and/or mTRP) may scale with the number of cell/PCI candidates. To give an example, in legacy, the UE is configured with one ServingCellConfigCommon information element (IE) (or two, if in Dual Connectivity, for PCell and PSCell). In L1/L2 centric inter-cell mobility and/or in mTRP, if the UE is configured with KI cell/PCI candidates for the PCell and K2 cell/PCI candidates for the PSCell, the UE may end up needing K1+K2 ServingCellConfigCommon instances (or equivalent IE for L1/L2 centric inter-cell mobility).

Furthermore, the embodiments also provide benefits in the case the configuration for L1/L2 centric inter-cell mobility and/or mTRP can be included in RRC Resume, regardless if the configuration is stored when the UE is suspended. That in itself represents a gain as it speeds up the timing for configuring L1/L2 centric inter-cell mobility and/or inter-cell mTRP, and, prevents the need for an additional RRC Reconfiguration after the Resume procedure.

### BRIEF DESCRIPTION OF THE DRAWINGS

Exemplary embodiments will be described in more detail with reference to the following figures, in which:

FIG. 1 illustrates a mobility scenario.

FIG. 2 illustrates a mTRP scenario.

FIG. 3 illustrates a set of SpCells for N cell groups configured for a UE.

FIG. 4 illustrates a set of SCells for N cell groups configured for a UE.

FIG. 5 illustrates a scenario depicting the inter-cell mTRP transmission/reception.

FIG. 6 illustrates a flow chart of a method for handling a resume-suspend procedure, according to an embodiment.

FIG. 7 illustrates a signal flow for handling a resume-suspend procedure, according to an embodiment.

FIG. 8 illustrates a flow chart of a method in a wireless device for handling a resume-suspend procedure, according to an embodiment.

FIG. 9 illustrates a flow chart of a method in a first network node for handling a resume-suspend procedure, according to an embodiment.

FIG. 10 illustrates a flow chart of a method in a second network node for handling a resume-suspend procedure, according to an embodiment.

FIG. 11 shows an example of a communication system, according to an embodiment.

FIG. 12 shows a schematic diagram of a UE, according to an embodiment.

FIG. 13 shows a schematic diagram of a network node, according to an embodiment.

FIG. 14 illustrates a block diagram of a host.

FIG. 15 illustrates a block diagram illustrating a virtualization environment.

FIG. 16 shows a communication diagram of a host.

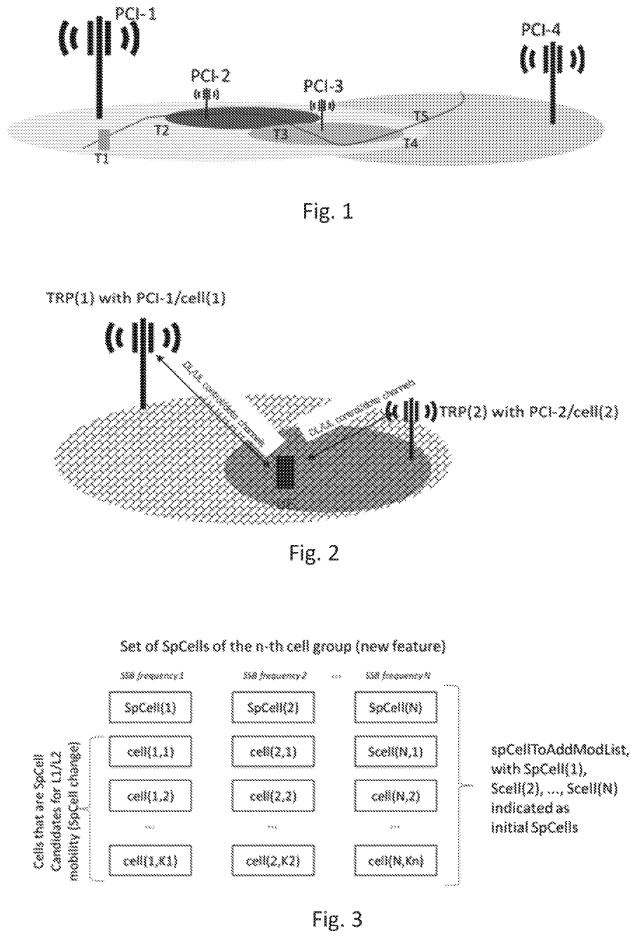

### DETAILED DESCRIPTION

Some of the embodiments contemplated herein will now be described more fully with reference to the accompanying drawings. Embodiments are provided by way of example to convey the scope of the subject matter to those skilled in the art.

### L1/L2 Centric (Inter-Cell) Mobility

The disclosure refers to the term “L1/L2 inter-cell centric mobility” but it can interchangeably be used with the terms L1/L2 mobility, L1-mobility, L1/L2 centric inter-cell mobility, L1/L2-centric mobility, or Dynamic Point Selection (DPS). The term is also used to refer to the feature of inter-cell multi-TRP (mTRP), though some specific examples for mTRP are given hereinbelow.

Even though 3GPP has not decided how a L1/L2 inter-cell centric mobility and inter-cell mTRP should be standardized in its detailed level, the understanding for the purpose of this disclosure is that the UE in RRC_CONNECTED is connected (i.e. being served by) to a serving cell, considered to be the PCell (or current PCell). In the multi-beam scenario (e.g. in FR2 or some FR1 scenarios), a cell/PCI can be associated to multiple SSBs, and during a half-frame, different SSBs may be transmitted in different spatial directions (i.e. using different beams, spanning the coverage area of a cell).

Even though the term “L1/L2 inter-cell centric mobility” and “inter-cell mTRP” has the term “inter-cell”, the UE's configuration has more than one PCI associated to it; there are at least 2 approaches to create that association:
Intra-cell multi-PCI L1/L2 centric mobility and/or intra-cell multi-PCI mTRP, where the same serving cell configuration is associated to more than one PCI. In this case, the UE's Serving Cell configuration can be associated to multiple PCIs and the UE can change (or add/activate/deactivate/release) the PCI associated to the serving cell in a given serving frequency (e.g. the SpCell PCI) upon reception of a L1/L2 signaling, such as a MAC CE. In this case, one example of L1/L2 centric inter-cell mobility and/mTRP configuration can be the set of parameters, fields, and IEs per PCI of the serving cell, where the UE operates according to the configuration per PCI, depending which PCI is considered the serving cell's PCI. For example, a configuration per PCI may be a subset of parameters, fields and/or IEs as defined for PCI-specific parameters (e.g. in the IE ServingCellConfigCommon) and/or for UE-specific parameters, where each may have a different set of values for each configured PCI.
Inter-cell multi-PCI L1/L2 centric mobility and/or inter-cell mTRP, where the UE has several serving cell configurations with respective PCIs associated. In this case, the UE's configuration can be associated to multiple cells, each configuration associated to its cell. The UE can change (or add/activate/deactivate/release) the cell (and the PCI) in a given serving frequency (e.g. the SpCell) upon reception of a L1/L2 signaling, such as a MAC CE, and start operating according to the configuration associated to the cell the UE has changed to. In this case, one example of L1/L2 centric inter-cell and/or inter-cell mTRP configuration can be the set of parameters, fields, and IEs per PCI of the serving cell, where the UE operates according to the configuration per cell, depending which cell is considered the serving cell in that serving frequency. For example, a configuration per cell may be a subset of parameters, fields and/or IEs as defined for cell-specific parameters (e.g. in the IE ServingCellConfigCommon) and/or for UE-specific parameters, where each may have a different set of values for each configured cell.

Further details about these two approaches are explained below. In particular, examples of what may correspond to L1/L2 centric inter-cell mobility configuration(s) and/or inter-cell mTRP configurations are provided.

### L1/L2 Centric (Inter-Cell) Mobility Signaling Alternatives

The UE may receive a first configuration and/or a second configuration for L1/L2 centric inter-cell mobility from the network node.

For example, these configurations for L1/L2 inter-cell centric mobility may comprise TCI state configurations for which QCL sources are associated to multiple PCI(s) and/or cells (one cell/PCI per each TCI). The UE may be configured with additional cells and/or PCIs, where each additional cell and/or PCI, or equivalently stated, any SSB beam related to the additional cell and/or PCI, can be used as a QCL source in a TCI state the UE is configured with. These TCI state configurations, each having its own QCL source and associated RS for one of the multiple configured PCI(s) and/or cells may be configured in the UE-specific configurations, such as in the IE SpCellConfig (as defined in TS 38.331), in particular in the spCellConfigDedicated field or IE ServingCellConfig, e.g. as part of the Physical Downlink Shared Channel (PDSCH) and/or Physical Downlink Control Channel (PDCCH) configuration(s). For example, the configuration of TCI state(s) for multiple PCIs and/or cells can be provided as shown in Table 1:

Table 1: configuration of TCI states for multiple PCIs and/or cells

TCI configurations =
[TCI configuration 1, . . . , TCI configuration K]

TCI configuration 1
QCL source
RS of cell-1
TCI configuration 2
QCL source: RS of cell-5
. . .
TCI configuration K
QCL source: RS of cell-5
. . .

In previous systems, the UE assumes that the QCL source of a TCI state is a RS associated to the serving cell's first PCI (i.e. the PCI in ServingCellConfigCommon). In this disclosure, the UE can be configured with a different PCI and/or cell (SSB of different PCI) in the TCI state configuration. The association between the QCL source of the TCI state and the cell and/or PCI may be done by referring to a PCI in the TCI state configuration or via a cell index (e.g. serving cell index). An example where another PCI is added to the TCI state is shown below as underlined:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex OPTIONAL, -- Need R |

phyCellId PhysCellId OPTIONAL, -- Need R

| | |
|---|---|
| bwp-Id | BWP-Id |

OPTIONAL, -- Cond CSI-PS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}
-- TAG-TCI-STATE-STOP
-- ASN1STOP

QCL-Info field descriptions
phyCellId
Physical cell identity associated to the reference
signal configured as QCL source.

One possible solution for this signaling is that the absence of phyCellId indicates to the UE that the PCI and/or cell to be assumed is the cell and/or PCI included in ServingCellConfigCommon, for that configured TCI state. There could be other solutions to associate an additional PCI to a QCL source of a TCI state, for example, a nested signaling where, for each PCI, the UE is configured with a list of TCI state configurations.

In one solution, the QCL information configuration of a TCI state configuration contains a reference/pointer to the cell the reference signal indicated is associated to, where the reference/pointer is the PCI and Absolute Radio Frequency Channel Number (ARFCN) of the non-serving cell, as shown below:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

```
OPTIONAL, -- Need R
  physCellId PhysCellId OPTIONAL
  downlinkConfigCommon DownlinkConfigCommon OPTIONAL,
```

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}
-- TAG-TCI-STATE-STOP
-- ASN1STOP

QCL-Info field descriptions
cell
The UE's serving cell in which the referenceSignal is configured.
If the field is absent, it applies to the serving cell in which the
TCI-State is configured. The RS can be located on a serving cell
other than the serving cell in which the TCI-State is configured
only if the qcl-Type is configured as typeC or typeD. See TS
38.214 [19] clause 5.1.5. if the TCI state is associated to a non-
serving cell, this field is absent.
physCellId
PCI of a non-serving cell in which the referenceSignal is
configured. The field is absent if the referenceSignal
is configured for a serving cell.
downlinkConfigCommon
Downlink frequency information of a non-serving cell in
which the referenceSignal is configured.

In another solution, the QCL information configuration of a TCI state configuration contains a reference/pointer to the cell the reference signal indicated is associated to, where the reference/pointer is a cell index (e.g. non-serving cell index), as follows:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R
nsCellIndex NSCellIndex,

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, |

typeC, typeD},
...
}
-- TAG-TCI-STATE-STOP
-- ASN1STOP
// Non-serving cell configurations
nsCellToAddModList SEQUENCE (SIZE (1..maxNrofNSCells)) OF
NSCellConfig

| NSCellConfig ::= | SEQUENCE { | |
|---|---|---|
| nsCellIndex | NSCellIndex, | |
| nsCellConfigCommon | ServingCellConfigCommon | OPTIONAL, |

}
[...]

QCL-Info field descriptions
nsCellIndex
Non-serving cell in which the referenceSignal is configured.
The index is associated to a non-serving cell
configuration i.e. a ServingCellConfigCommon.

Note: the term non-serving cell is used to refer to a cell that is configured but that is not currently the serving cell in the serving frequency.

In another solution, relying on that the QCL information of a TCI state configuration can be associated to a non-serving cell (e.g. an inter-frequency neighbor) and that multiple TCI states could be associated to the same non-serving cell, for each non-serving cell reference/pointer there can be a list of TCI states configuration(s), as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE |

```
(SIZE(1..maxNrofTCI-States)) OF TCI-State OPTIONAL, -- Need N
  [...]
// TCI state configuration for non-serving cell(s)
    tci-StatesToAddModList-NSC SEQUENCE
(SIZE(1..maxNrof-NSC)) OF TCI-State-NSC OPTIONAL,
TCI-State-NSC ::= SEQUENCE {
    nsCellIndex NSCellIndex,
    tci-StatesToAddModList SEQUENCE
(SIZE(1..maxNrofTCI-States)) OF TCI-State
}
```

Hence, any TCI state has as QCL source a RS associated to the non-serving cell associated to that index, e.g. nsCellIndex. Let's assume an example where 4 TCI states are associated to 2 non-serving cells, e.g. TCI=1 and TCI=2 with non-serving cell A whose non-serving cell index=7, and TCI=3 and TCI=4 with non-serving cell B, whose non-serving cell index=13. In this case, the PDSCH configuration (or any other IE containing TCI state configuration(s)) can contain within tci-StatesToAddModList-NSC the following:
TCI-State-NSC(1), for non-serving cell A; nsCellIndex=7, TCI=1 and TCI=2 with reference signals in QCL source associated to cell A, indexed by nsCellIndex=7;
TCI-State-NSC(2), for non-serving cell B; nsCellIndex=13, TCI=3 and TCI=4 with reference signals in QCL source associated to non-serving cell B, indexed by nsCellIndex=13.

In another solution, relying on that the QCL information of a TCI state configuration can be associated to a non-serving cell (e.g. an inter-frequency neighbor) and that multiple TCI states could be associated to the same non-serving cell, for each non-serving cell reference/pointer there can be a list of TCI states configuration(s), where the reference/pointer is the PCI and the ARFCN, as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE |

```
(SIZE(1..maxNrofTCI-States)) OF TCI-State OPTIONAL, -- Need N
  [...]
// TCI state configuration for non-serving cell(s)
    tci-StatesToAddModList-NSC SEQUENCE
(SIZE(1..maxNrof-NSC)) OF TCI-State-NSC OPTIONAL,
TCI-State-NSC ::= SEQUENCE {
    physCellId PhysCellId OPTIONAL
    downlinkConfigCommon DownlinkConfigCommon OPTIONAL,
    tci-StatesToAddModList SEQUENCE
(SIZE(1..maxNrofTCI-States)) OF TCI-States
}
```

Hence, any TCI state has as QCL source a RS associated to the non-serving cell associated to the non-serving cell PCI and the non-serving cell downlink frequency information configuration (that contains the SSB ARFCN). Let's assume an example where 4 TCI states are associated to 2 non-serving cells, e.g. TCI=1 and TCI=2 with non-serving cell A whose non-serving cell PCI=5 and ARFCN=X, and TCI=3 and TCI=4 with non-serving cell B, whose non-serving cell PCI=13 and ARFCN=Y. In this case, the PDSCH configuration (or any other IE containing TCI state configuration(s)) can contain within tci-StatesToAddModList-NSC the following:
TCI-State-NSC(1), for non-serving cell A; PCI=5 and ARFCN=X; TCI=1 and TCI=2 with reference signals in QCL source associated to cell A;
TCI-State-NSC(2), for non-serving cell B; PCI=13 and ARFCN=Y; TCI=3 and TCI=4 with reference signals in QCL source associated to non-serving cell B.

To give an idea of the signaling gain, without the structure above the following would have been received by the UE (twice as long):
TCI-State-NSC(1), for non-serving cell A; PCI=5 and ARFCN=X; TCI=1 with reference signals in QCL source associated to cell A;
TCI-State-NSC(2), for non-serving cell A; PCI=5 and ARFCN=X; TCI=2 with reference signals in QCL source associated to cell A;
TCI-State-NSC(3), for non-serving cell B; PCI=13 and ARFCN=Y; TCI=3 with reference signals in QCL source associated to non-serving cell B;
TCI-State-NSC(4), for non-serving cell B; PCI=13 and ARFCN=Y; TCI=4 with reference signals in QCL source associated to non-serving cell B;

In another solution, the QCL information configuration of a TCI state configuration contains a reference/pointer to the cell the RS indicated is associated to, where the reference/pointer is the PCI and a reference to a measurement object configuration (such as measurement object identifier) for the non-serving cell is as follows:

| -- ASN1START | |
|---|---|
| -- TAG-TCI-STATE-START | |
| QCL-Info ::= | SEQUENCE { |
| cell | ServCellIndex |
| OPTIONAL, -- Need P | |
| physCellId PhysCellId OPTIONAL | |
| measObjectId MeasObjectId OPTIONAL, | |
| bwp-Id | BWP-Id |
| OPTIONAL, -- Cond CSI-RS-Indicated | |
| referenceSignal | CHOICE { |
| csi-rs | NZP-CSI-RS-ResourceId, |
| ssb | SSB-Index |
| }, | |
| qcl-Type | ENUMERATED {typeA, typeB, typeC, |

typeD},
...
}
-- TAG-TCI-STATE-STOP
-- ASN1STOP

QCL-Info field descriptions
physCellId
PCI of a non-serving cell in which the referenceSignal
is configured. The field is absent if the
referenceSignal is configured for a serving cell.
meas ObjectId
Indicates the measurement object (as in MeasConfig)
containing the SSB properties for that non-serving
cell used as QCL source for that TCI state such as
frequency information of a non-serving cell in
which the referenceSignal is configured.

For L1/L2 inter-cell centric mobility, the measurement configuration for beam measurement and beam reporting, e.g. L1 Reference Signal Received Power (RSRP) per SSB and/or Channel State Information-RS (CSI-RS) can also correspond to the configuration for L1/L2 centric inter-cell mobility.

The first and/or second configurations for L1/L2 centric inter-cell mobility may comprise cell specific parameters, equivalent to at least a subset of the fields and/or IEs within ServingCellConfigCommon as defined in TS 38.331. Upon receiving the L1/L2 centric inter-cell mobility command, e.g. a MAC CE indicating a TCI state whose QCL source is an RS of a PCI or cell that is not the SpCell (i.e. not the PSCell or the PSCell), the UE performs L1/L2 centric inter-cell mobility. In other words, the UE changes cells (e.g. changes from the serving cell to the new cell associated to the indicated TCI state).

In an example, the UE is configured with multiple cells in the same serving frequency (e.g. same SSB ARFCN and/or same subcarrier spacing), where these configurations may correspond to L1/L2 centric inter-cell mobility configurations. One of the cells is considered to be the serving cell in that serving frequency and the others are the candidates for L1/L2 centric inter-cell mobility (where the UE can move to upon reception of the L1/L2 signaling, e.g. MAC CE).

One example is shown in FIG. 3, for the case the UE is configured with one SpCell and a set of candidate SpCells per SSB frequency, for N cell groups. The first cell group can be the Master Cell Group (MCG) and the second cell group may be the Secondary Cell Group (SCG).

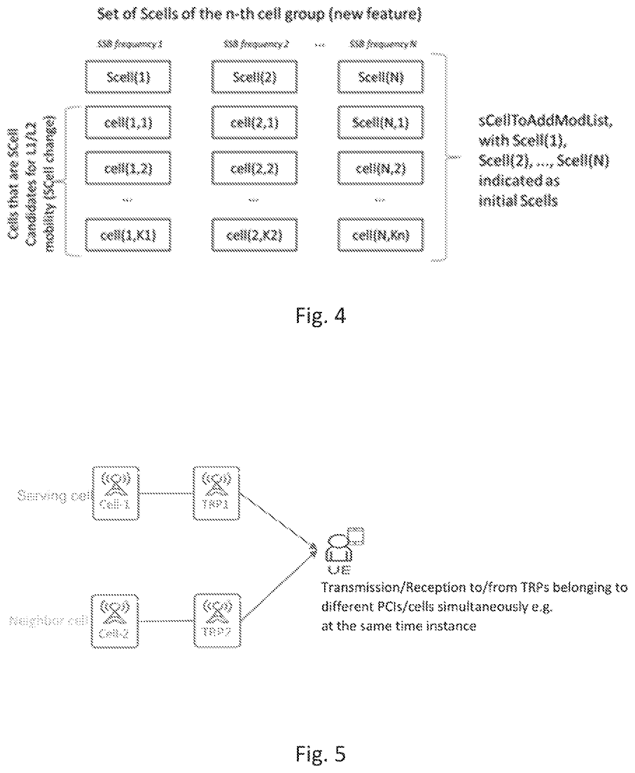

Another example is shown in FIG. 4 for the case the UE is configured with one SCell and a set of SCell candidates per SSB frequency.

Each cell and/or PCI may have its set of cell-specific parameters, e.g. within a ServingCellConfigCommon, which may correspond to the L1/L2 centric inter-cell mobility configuration.

Each cell and/or PCI may have its set of UE-specific parameters, e.g. within a ServingCellConfigCommon, which may correspond to the L1/L2 centric inter-cell mobility configuration.

The cell-specific parameters may be configured in the IE CellGroupConfig, for a cell group, e.g. MCG, SCG, or both MCG and SCG.

Although these examples have been presented in terms of L1/L2 centric inter-cell mobility, they may also be applicable for inter-cell mTRP.

### Inter-Cell mTRP

FIG. 5 depicts examples for the inter-cell mTRP solutions. In this scenario, the UE can transmit and receive data from TRPs of the serving cell/PCI and from/to the TRPs of a neighbor cell/PCI. In this scenario, the UE is configured with TCI states associated to the serving cell PCI (i.e. the cell field in the QCL-Info indicates the corresponding serving cell index) and also the neighbor cell PCI (i.e. the cell field in the QCL-Info indicates the corresponding neighbor cell information) and one needs a MAC CE using which the network can indicate the serving PCI related TCI state and neighbor cell PCI related TCI state.

To ensure that the UE can transmit/receive data to/from the neighbor cell, the relevant downlink control/data channels, such as PDSCH, PDCCH, and/or uplink control/data channels such as Physical Uplink Shared Channel (PUSCH) and Physical Uplink Control Channel (PUCCH) configurations of the neighbor cell need to be made available to the UE. This has also been agreed in RAN2#114 meeting.

Scenario 1: Inter-cell multi-TRP-like model

1. UE receives from serving cell, configuration of SSBs of
the TRP with different PCI for beam measurement, and
configurations needed to use radio resources for data
transmission/reception including resources for different PCI.
2. UE performs beam measurement for the TRP with different
PCI and report it to serving cell.
3. Based on the above reports, TCI state(s) associated to the
TRP with different PCI is activated from the serving
cell (by L1/L2 signaling).
4. UE receives and transmits using UE-dedicated channel on
TRP with different PCI.
5. UE should be in coverage of a serving cell always, also for
multi-TRP case, e.g. UE should use common channels
BCCH PCH etc. from the serving cell (as in legacy).

There are different ways of modeling the inter-cell mTRP configuration.

### 1) Inter-PCI mTRP Configuration

In this modeling, all the PCIs amongst which the mTRP operations can be enabled with more than one PCI to a UE are part of the same servingCellConfigCommon except for the physCellID, i.e., all the common configurations in these PCIs are the same. They could even have the same System information Block (SIB1) transmission including the Cell Global Identity (CGI) information. Such a configuration might be possible to overcome the restriction of the maximum number of SSBs that can be associated to a PCI in the Master Information Block (MIB).

Further, from the UE's mTRP operation point of view, the UE needs to receive the dedicated configuration associated to the PDSCH, PDCCH, PUSCH and PUCCH configurations associated to these PCIs and then the UE can use these configurations to transmit/receive to these PCIs while being still served by the serving cell. In this case, the PCI, or another identifier, becomes a “title”, or “handle” to the configuration that is associated to the PCI. This can be viewed as “part of the configuration” as mentioned above.

### 2) Inter-Cell mTRP Configuration

In this modeling, each of the PCIs amongst which the mTRP operations can be enabled with more than one PCI to a UE have their own servingCellConfigCommon, i.e., all the common configurations in these PCIs are independent of one another. They could even have the same SIB1 transmission including the CGI information. Such a configuration allows for the existing deployments to use the new feature of inter-cell mTRP operation without impacting the SIB1 and the servingCellConfigCommon related configurations.

Further, from the UE's mTRP operation point of view, here also the UE needs to

receive the dedicated configuration associated to the PDSCH, PDCCH, PUSCH and PUCCH configurations associated to these PCIs and then the UE can use these configurations to transmit/receive to these PCIs while being still served by the serving cell. In this case, the PCI, or another identifier, becomes a “title”, or “handle” to the configuration that is associated to the PCI. This can be viewed as “part of the configuration” as mentioned above.

### Inter-Cell Multi-TRP Signaling Alternatives

The UE may receive a first configuration and/or a second configuration for inter-cell mTRP from the network node.

In the following, examples of the first and/or second configurations for inter-cell mTRP are described.

For inter-cell mTRP operation, the TCI state configurations for which QCL sources are associated to multiple PCI(s) and/or cells (one cell/PCI per each TCI) may correspond to inter-cell mTRP configuration(s). The UE may be configured with additional cells and/or PCIs, where each additional cell and/or PCI, or equivalently stated, any SSB beam related to the additional cell and/or PCI, can be used as a QCL source in a TCI state the UE is configured with. These TCI state configurations, each having its own QCL source and associated RS for one of the multiple configured PCI(s) and/or cells may be configured in the UE-specific configurations, such as in the IE SpCellConfig (as defined in TS 38.331), in particular in the spCellConfigDedicated field or IE ServingCellConfig, e.g. as part of the PDSCH and/or PDCCH configuration(s). In summary, the configuration of TCI state(s) for multiple PCIs and/or cells are as provided in Table 1.

In previous systems, the UE assumes that the QCL source of a TCI state is a RS associated to the serving cell's PCI (i.e. the PCI in ServingCellConfigCommon). In the disclosure, the UE can be configured with a different PCI and/or cell (SSB of different PCI) in the TCI state configuration. The association between the QCL source of the TCI state and the cell and/or PCI may be done by referring to a PCI in the TCI state configuration or via a cell index (e.g. serving cell index).

There could be different solutions to associate an additional PCI to a QCL source of a TCI state, for example, a nested signaling where for each PCI the UE is configured with a list of TCI state configurations. If the association between the QCL source of the TCI state and the cell and/or PCI is done by referring to a PCI, then this PCI could also be provisioned as part of the dedicated servingCellConfig, where a new field for PCI is introduced (either in the servingCellConfig or in one of the fields included in the servingCellConfig). In the following example, the list of PCIs amongst which the inter-cell mTRP operation is allowed is configured as part of the servingCellConfig, as defined in TS 38.331 (reproduced below):

| | |
|---|---|
| ServingCellConfig ::= | SEQUENCE { |
| tdd-UL-DL-ConfigurationDedicated | TDD-UL-DL- |

ConfigDedicated OPTIONAL, -- Cond TDD
[...]
ommitted
[[

| | |
|---|---|
| directionalCollisionHandling-r16 | ENUMERATED {enabled} |

OPTIONAL, -- Need R

| | |
|---|---|
| channelAccessConfig-r16 | SetupRelease { |
| ChannelAccessConfig-r16 } | OPTIONAL -- Need M |

```
  ]]
  phyCellIdList SEQUENCE (SIZE
(1..maxNrofmTRPCells)) OF PhysCellId OPTIONAL, -- Need R
}
```

In one solution, the ServingCellConfig could in turn contain a list of a dedicated serving cell configurations to be used by the UE when the UE is configured with a mTRP operation with a PCI that is different from the serving cell PCI.

| | |
|---|---|
| ServingCellConfig ::= | SEQUENCE { |

// other parameters in ServingCellConfig
[...]

| | |
|---|---|
| interCellmTRPList | SEQUENCE (SIZE (1..maxNrofmTRPCells)) |

OF InterCellmTRP OPTIONAL, -- Need R
}

| InterCellmTRP ::= | SEQUENCE { | |
|---|---|---|
| physCellId | PhysCellId | OPTIONAL, |
| servingCellConfigDedicated | ServingCellConfig | OPTIONAL, |

}

In one solution, the QCL information configuration of a TCI state configuration contains a reference/pointer to the cell with which the indicated RS is associated, where the reference/pointer is the PCI and ARFCN of the non-serving cell, as shown below:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

```
OPTIONAL, -- Need R
    physCellId PhysCellId OPTIONAL,
    servingCellConfigDedicated ServingCellConfig OPTIONAL,
```

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}
-- TAG-TCI-STATE-STOP
-- ASN1STOP

QCL-Info field descriptions
cell
The UE's serving cell in which the referenceSignal is configured.
If the field is absent, it applies to the serving cell in which the
TCI-State is configured. The RS can be located on a serving cell
other than the serving cell in which the TCI-State is configured
only if the qcl-Type is configured as typeC or typeD. See TS
38.214 [19] clause 5.1.5. if the TCI state is associated to a non-
serving cell, this field is absent.
physCellId
PCI of a non-serving cell in which the referenceSignal is
configured. The field is absent if the refererenceSignal
is configured for a serving cell.
servingCellConfigDedicated
Dedicated serving cell configuration information of a non-
serving cell in which the referenceSignal is configured.

In another solution, the QCL information configuration of a TCI state configuration contains a reference/pointer to the cell with which the indicated RS is associated, where the reference/pointer is a cell index (e.g. mTRP cell index), as shown below:

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R
mTRPCellIndex MTRPCellIndex,

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, |

typeC, typeD},
...
}
-- TAG-TCI-STATE-STOP
-- ASN1STOP
// m-TRP cell configurations
mTRPCellToAddModList SEQUENCE (SIZE (1.. maxNrofmTRPCells))
OF MTRPCellConfig

| | |
|---|---|
| MTRPCellConfig::= | SEQUENCE { |
| mTRPCellIndex | mTRPCellIndex, |
| mTRPCellConfig | ServingCellConfig OPTIONAL, |

}
[...]

QCL-Info field descriptions
mTRPCellIndex
Neighboring cell in which the referenceSignal is configured.
The index is associated to a neighboring
cell configuration i.e. a ServingCellConfig.

In another solution, relying on that the QCL information of a TCI state configuration can be associated to a non-serving cell (e.g. an inter-frequency neighbour) and that multiple TCI states could be associated to the same non-serving cell, for each non-serving cell reference/ pointer there can be a list of TCI states configuration(s), as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE |

```
(SIZE (1..maxNrofTCI-States)) OF TCI-State OPTIONAL, -- Need N
  [...]
// TCI state configuration for non-serving cell(s)
    tci-StatesToAddModList-NSC SEQUENCE
(SIZE(1..maxNrof-NSC)) OF TCI-State-NSC OPTIONAL,
TCI-State-NSC ::= SEQUENCE {
    nsCellIndex NSCellIndex,
    tci-StatesToAddModList SEQUENCE
(SIZE(1..maxNrofTCI-States)) OF TCI-State
}
```

Hence, any TCI state has as QCL source a RS associated to the non-serving cell associated to that index, e.g. nsCellIndex. Let's assume an example where 4 TCI states are associated to 2 non-serving cells, e.g. TCI=1 and TCI=2 with non-serving cell A, whose non-serving cell index=7, and TCI=3 and TCI=4 with non-serving cell B, whose non-serving cell is index=13. In this case, the PDSCH configuration (or any other IE containing TCI state configuration(s)) can contain within tci-StatesToAddModList-NSC the following:
TCI-State-NSC(1), for non-serving cell A; nsCellIndex=7; TCI=1 and TCI=2 with reference signals in QCL source associated to cell A, indexed by nsCellIndex=7;
TCI-State-NSC(2), for non-serving cell B; nsCellIndex=13; TCI=3 and TCI=4 with reference signals in QCL source associated to non-serving cell B, indexed by nsCellIndex=13.

In another solution, relying on that the QCL information of a TCI state configuration can be associated to a non-serving cell (e.g. an inter-frequency neighbour) and that multiple TCI states could be associated to the same non-serving cell, for each non-serving cell reference/pointer there can be a list of TCI states configuration(s), wherein the reference/pointer is the PCI and the ARFCN, as follows:

| | |
|---|---|
| PDSCH-Config ::= | SEQUENCE { |

[...]
// legacy TCI state configuration for serving cell(s)

| | |
|---|---|
| tci-StatesToAddModList | SEQUENCE (SIZE(1..maxNrofTCI- |

States)) OF TCI-State OPTIONAL, -- Need N
[...]
// TCI state configuration for non-serving cell(s)

| | |
|---|---|
| tci-StatesToAddModList-NSC | SEQUENCE (SIZE(1..maxNrof- |

NSC)) OF TCI-State-NSC OPTIONAL,

| TCI-State-NSC ::= | SEQUENCE { | |
|---|---|---|
| physCellId | PhysCellId | OPTIONAL |
| downlinkConfigDedicate | BWP-DownlinkDedicated | OPTIONAL, |

| | |
|---|---|
| tci-StatesToAddModList | SEQUENCE (SIZE(1..maxNrofTCI-States)) |

OF TCI-State
}

Hence, any TCI state has as QCL source a RS associated to the non-serving cell associated to the non-serving cell PCI and the non-serving cell downlink frequency information configuration (that contains the SSB ARFCN). Let's assume an example where 4 TCI states are associated to 2 non-serving cells, e.g. TCI=1 and TCI=2 with non-serving cell A, whose non-serving cell PCI=5 and ARFCN=X, and TCI=3 and TCI=4 with non-serving cell B, whose non-serving cell PCI=13 and ARFCN=Y. In this case, the PDSCH configuration (or any other IE containing TCI state configuration(s)) can contain within tci-StatesToAddModList-NSC the same information as in the case for L1/L2 inter-cell centric mobility (as described earlier). The gain saved using this structure is the same as well.

In another solution, the QCL information configuration of a TCI state configuration contains a reference/pointer to the cell the RS indicated is associated to, where the reference/pointer is the PCI and a reference to a measurement object configuration (such as measurement object identifier) for the non-serving cell is the same as in the case for L1/L2 centric inter cell mobility, as described earlier.

For inter-cell mTRP operation, the measurement configuration for beam measurement and beam reporting, e.g. L1 RSRP per SSB and/or CSI-RS can also correspond to the configuration for inter-cell mTRP operation.

The first and/or second configurations for inter-cell mTRP may comprise cell specific parameters, equivalent to at least a subset of the fields and/or IEs within ServingCellConfig as defined in TS 38.331. Upon receiving the inter-cell mTRP command, e.g. MAC CE indicating a TCI state whose QCL source is an RS of a PCI or cell that has a PCI other than the serving cell PCI on that frequency, the UE starts receiving/transmitting the PDSCH/PUSCH associated to that TCI state. The UE continues to be in the coverage of the serving cell PCI, while it starts receiving data in the neighbor cell via the inter-cell mTRP operation.

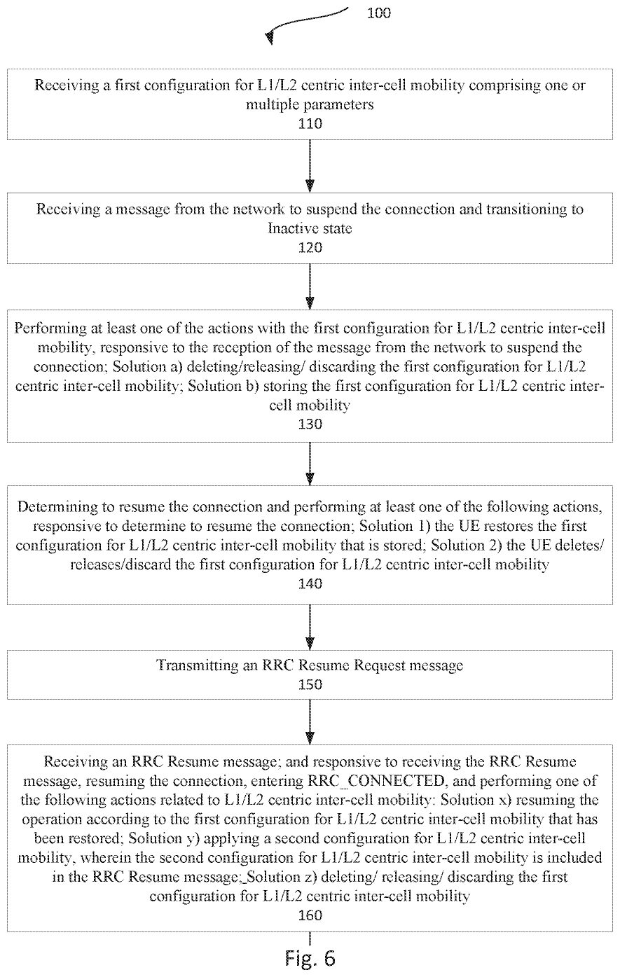

FIG. 6 illustrates a method 100 in a wireless device or UE for handling suspend-resume in the context of L1/L2 centric inter-cell mobility and/or inter-cell mTRP. The method may comprise the following steps:

Step 110: Receiving a first configuration for L1/L2 centric inter-cell mobility or for mTRP operation, the first configuration comprising one or multiple parameters;

Step 120: Receiving a message (e.g. suspend message) from the network node to suspend the connection and transitioning to Inactive state and suspending the connection (e.g. suspending at least one configured SSRB and at least one DRBs);

Step 130: Performing at least one of the actions with the first configuration for L1/L2 centric inter-cell mobility or mTRP operation, responsive to the reception of the message from the network node to suspend the connection; Solution a) deleting/releasing/discarding the first configuration for L1/L2 centric inter-cell mobility or mTRP operation; Solution b) storing the first configuration for L1/L2 centric inter-cell mobility or mTRP operation.

Step 140: Determining to resume the connection and performing at least one of the following actions, responsive to determining to resume the connection; Solution 1) the UE restores the first configuration for L1/L2 centric inter-cell mobility or mTRP operation that is stored; Solution 2) the UE deletes/releases/discards the first configuration for L1/L2 centric inter-cell mobility or mTRP operation;

Step 150: Transmitting an RRC Resume Request message; and

Step 160: Receiving an RRC Resume message; and responsive to receiving the RRC Resume message, resuming the connection, entering RRC_CONNECTED, and performing one of the following actions related to L1/L2 centric inter-cell mobility or mTRP operation; Solution x) resuming the operation according to the first configuration for L1/L2 centric inter-cell mobility or mTRP operation that has been restored; Solution y) applying a second configuration for L1/L2 centric inter-cell mobility or mTRP operation, wherein the second configuration for L1/L2 centric inter-cell mobility or mTRP operation is included in the RRC Resume message; Solution z) deleting/releasing/discarding the first configuration for L1/L2 centric inter-cell mobility or mTRP operation.

The method above describes that the UE receives a first configuration for L1/L2 centric inter-cell mobility, then is suspended and later resumes. However, some of the steps do not necessarily require the UE to have received the first configuration for L1/L2 centric inter-cell mobility. For example, the UE may have been suspended without having been configured with the first configuration for L1/L2 centric inter-cell mobility. Then, when the UE resumes, the UE could anyways according to the method receive an RRCResume message including a configuration for L1/L2 centric inter-cell mobility.

The details of the different steps will be described next.

### In Step 110

The first configuration for L1/L2 centric inter-cell mobility or mTRP operation (as described above) may be received in an RRC message, for example, an RRC Reconfiguration (e.g. RRCReconfiguration as defined in TS 38.331, and/or RRCConnectionReconfiguration as defined in TS 36.331).

The one or multiple/several parameters may correspond to cell-specific parameters, where the UE is configured with cell-specific parameters for each target candidate cell for L1/L2 centric inter-cell mobility or mTRP. This would imply that first configuration refers to a configuration which is specific to a cell.

The cell-specific parameters for each target candidate cell for L1/L2 centric inter-cell mobility or mTRP operation can be parameters, e.g. IEs and/or fields, in the IE ServingCellConfigCommon as defined in TS 38.331. In other words, the UE can be configured with one or multiple instances of the IE ServingCellConfigCommon, per target cell candidate.

The one or multiple parameters may correspond to PCI-specific parameters, where the UE is configured with PCI-specific parameters for each target PCI candidate for L1/L2 centric inter-cell mobility or mTRP (e.g. in the case the serving cell configuration may have multiple PCIs associated, where the PCI for the PCell may change based on the L1/L2 centric inter-cell mobility signaling or mTRP). This would imply that first configuration refers to a configuration which is specific to a PCI.

The first configuration for L1/L2 centric inter-cell mobility or mTRP may be for the MCG.

The first configuration for L1/L2 centric inter-cell mobility or mTRP may be for the SCG, if the UE is capable of L1/L2 centric inter-cell mobility and Dual Connectivity.

The first configuration for L1/L2 centric inter-cell mobility or mTRP may be for both the MCG and the SCG, though they could be divided in sub-configurations, where the first sub-configuration is for the MCG, and the second for the SCG.

In one example, the sub-configuration for L1/L2 centric inter-cell mobility or mTRP done for the MCG may be the same as the one done for the SCG, e.g. if the sub-configuration for L1/L2 centric inter-cell mobility for the MCG is stored, the sub-configuration for L1/L2 centric inter-cell mobility for the SCG is stored.

In another example, the sub-configuration for L1/L2 centric inter-cell mobility or mTRP done for the MCG may differ from the actions done for the SCG.

### Step 120

In one example, the received message may correspond to an RRC Release message including a suspend configuration, e.g. RRCRelease including suspendConfig, as defined in TS 38.331. In another example, the received message may correspond to an RRC Suspend message.

The “Inactive state” may correspond to the RRC Inactive state as defined in TS 38.331. However, this state may be any power saving state the UE is configured with, such as IDLE with stored context, where mobility is typically UE specific and/or the UE monitors a paging channel.

Suspending the connection may correspond to suspending at least one configured Signaling Radio Bearers (SRBs) and at least one Data Radio Bearers (DRBs).

Suspending at least one SRB may correspond to suspending SRB1 and/or suspending at least one DRB.

Suspending the connection may also correspond to suspending at least one SRB.

### Step 130

An example for implementing Solution a) may be as follows. When entering RRC_INACTIVE the UE can store the RRC configuration except for the first configuration and/or at least one parameter of the first configuration. An example of how the RRC specifications could be modified to implement this is shown below.

```
5.3.8.3 Reception of the RRCRelease by the UE
The UE shall:
  [...]
  1> if the RRCRelease includes suspendConfig:
        [...]
    2> if the RRCRelease message with suspendConfig was
        received in response to an RRCResumeRequest or an
        RRCResumeRequest1:
          [...]
    2> else:
        3> store in the UE Inactive AS Context the current K_{gNB} and
          K_{RRCint} keys, the ROHC state, the stored QoS flow to
          DRB mapping rules, the C-RNTI used in the source PCell,
          the cellIdentity and the physical cell identity of the source
          PCell, the spCellConfigCommon within
          ReconfigurationWithSync of the NR PSCell (if
          configured) and all other parameters configured except for:
          - parameters within ReconfigurationWithSync of the PCell;
          - parameters within ReconfigurationWithSync of the NR
            PSCell, if configured;
          - parameters within MobilityControlInfoSCG of the E-
            UTRA PSCell, if configured;
          - servingCellConfigCommonSIB;
          - parameters for L1/L2 centric inter-cell mobility, if
          configured;
        [...]
    2> indicate the suspension of the RRC connection to upper layers;
    2> enter RRC_INACTIVE and perform cell selection as
        specified in TS 38.304 [20];
  1> else
    2> perform the actions upon going to RRC_IDLE as specified in
        5.3.11, with the release cause ‘other’.
```

In one example, the action of releasing is performed if the UE receives an indication in the message from the network node to suspend the connection. That indication could be included by the network node if the network node decides to discard the first configuration. By indicating the UE to also discard the first configuration, state/configuration mismatch can be avoided when the UE tries to resume.

In another example, solution a) could be modeled by the UE explicitly deleting/releasing/discarding the first configuration and/or at least one parameter of the first configuration, when entering RRC_INACTIVE.

Deleting/releasing/discarding the first configuration may correspond to discarding at least a subset of the parameters for the first configuration and/or parameters for at least one of the candidate cells.

For example, the subset may be the configurations of all the cells that are not the currently active serving cells. For example, if the UE is configured with an SpCell (e.g. cell-A) and candidates in the SpCell frequency (cell-B, cell-C, cell-D), the UE deletes the candidate cell configurations but stores the current SpCell configuration.

At the network side, the network (e.g. the source network node the UE is connected to when the UE receives the RRC Release message for transitioning to Inactive state) also deletes/releases/discards the first configuration as a way to prevent any state/configuration mismatch between the UE and the network when the UE tries to resume the connection and restores the stored parameters, i.e. the first configuration.

In addition, the UE can suspend operations related to the first configuration, e.g. suspend L1 measurements for L1/L2 centric inter-cell mobility, stop monitoring PDCCH, etc.

An example for implementing Solution b) could be as follows. The UE stores the RRC configuration when entering RRC_INACTIVE, including the first configuration and/or at least one parameter of the first configuration. One example is shown below on how this could be modeled to the RRC standard specifications:

```
5.3.8.3 Reception of the RRCRelease by the UE
The UE shall:
  [...]
  1> if the RRCRelease includes suspendConfig:
        [...]
    2> if the RRCRelease message with suspendConfig was received in
        response to an RRCResumeRequest or an RRCResumeRequest1:
          [...]
    2> else:
        3> store in the UE Inactive AS Context the current K_{gNB} and
          K_{RRCint} keys, the ROHC state, the stored QoS flow to DRB
          mapping rules, the C-RNTI used in the source PCell, the
          cellIdentity and the physical cell identity of the source
          PCell, the spCellConfigCommon within
          ReconfigurationWithSync of the NR PSCell (if configured),
          the parameters for L1/L2 centric inter-cell mobility (if
          configured) and all other parameters configured except for:
          - parameters within ReconfigurationWithSync of the PCell;
          - parameters within ReconfigurationWithSync of the NR
            PSCell, if configured;
          - parameters within MobilityControlInfoSCG of the
            E-UTRA PSCell, if configured;
          - servingCellConfigCommonSIB;
        [...]
    2> indicate the suspension of the RRC connection to upper layers;
    2> enter RRC_INACTIVE and perform cell selection as specified
        in TS 38.304 [20];
  1> else
    2> perform the actions upon going to RRC_IDLE as specified
        in 5.3.11, with the release cause ‘other’.
```

In one example, the action is performed if the UE receives an indication in the message from the network node to suspend the connection. That indication could be included by the network node if the network node decides to store the first configuration. By indicating the UE to also store the first configuration, state/configuration mismatch is avoided when the UE tries to resume. This may be useful if the network node knows the UE remains most likely under the coverage of the same cell and/or the same gNB-DU and/or baseband so that when the UE resumes at least a subset of candidate cells for L1/L2 centric inter-cell mobility remains the same, thus, signaling could be saved upon resume.

Solution b) can be also modeled by the UE explicitly storing the first configuration and/or at least one parameter of the first configuration, when entering RRC_INACTIVE.

Storing the first configuration may correspond to storing at least a subset of the parameters for the first configuration and/or parameters for at least one of the candidate cells.

At the network side, the network (e.g. the source network node the UE is connected to when the UE receives the RRC Release message for transitioning to Inactive state) also stores the first configuration as a way to prevent any state/configuration mismatch between the UE and the network, when the UE tries to resume the connection and restores the stored parameters, i.e. the first configuration.

In addition, the UE can suspend operations related to the first configuration, e.g. suspend L1 measurements for L1/L2 centric inter-cell mobility, stop monitoring PDCCH, etc.

The UE may store the first configuration in the UE Inactive AS Context.

### Step 140

For Solution 1), in one example, the UE restores the first configuration that is stored during the resume initiation (e.g. step 130 solution b)), before it transmits the RRC Resume Request message.

In one example, the UE restores the first configuration that is stored after it has transmitted the RRC Resume Request.

In one example, the UE restores the first configuration that is stored upon reception of the RRC Resume message.

In one example, the UE restores the first configuration that is stored by restoring a field and/or IE that is stored in the UE AS Inactive context.

In one example, the UE restores the first configuration that is stored by restoring the RRC configuration in the UE AS Inactive context.

In one example, the UE restores the first configuration that is stored by restoring the UE AS Inactive context.

For Solution 2) in one example, the UE deletes/releases/discards the first configuration during the resume initiation, which was stored, e.g. in step 130 in solution b). This is done in the case the network also deletes/releases/discards the first configuration when the UE is suspended and/or when the UE tries to resume, as a way to prevent any state/configuration mismatch between the UE and the network. An example of how this could be modeled in the RRC specifications is shown below.

```
5.3.13 RRC connection resume
5.3.13.2 Initiation
[...]
Upon initiation of the procedure, the UE shall:
        [...]
  1> if the UE is configured with L1/L2 centric inter-cell mobility:
    2> if the UE does not support maintaining L1/L2 centric inter-cell
        mobility configuration upon connection resumption:
        3> release the L1/L2 centric inter-cell mobility from the UE
          Inactive AS context, if stored;
  [...]
  1> initiate transmission of the RRCResumeRequest message or
    RRCResumeRequest1 in accordance with 5.3.13.3.
```

In one example, the UE deletes/releases/discards the first configuration during the resume initiation from the UE Inactive AS context, if it had been stored (e.g. step 130 solution b)).

In one example, this action may be done in response to an indication received by the UE during the resume procedure, e.g. provided in system information and/or in the RRC resume message (RRCResume as defined in TS 38.331).

In one example, this action may be done based on a UE capability; in other words, the action is performed if the UE is not capable of storing and/or restoring the first configuration; and/or the action is not performed if the UE is capable of storing and/or restoring the first configuration.

In one example, this action may be done if the UE tries to resume in a cell that is not one of the cells and/or not one of the PCIs part of the first configuration.

In one example, this action may be done if the UE tries to resume in a cell that is not the last serving cell, i.e. that is not the cell the UE was connected when it has received the last RRC Release message with suspend configuration.

The determination may be done at the RRC layer or at the higher layers, e.g. Non-Access Stratum (NAS) Layer requests a resume to the lower layer (i.e. to the RRC layer).

If the UE has not stored the first configuration, the UE can simply prepare to transmit an RRC Resume Request message and receive an RRC Resume message.

### Step 150

The RRC Resume Request message may correspond to an RRCResumeRequest or an RRCResumeRequest1 as defined in TS 38.331, containing a resume Message Authentication Code-Integrity (MAC-I), inactive-Radio network Temporary Identity (I-RNTI) and resume cause value.

### Step 160

In one example, solution x) can be applicable at least for the case the UE has stored the first configuration when it has entered RRC_INACTIVE (i.e. solution b) of step 130 for suspend).

Resuming the operation according to the first configuration can correspond to the UE performing actions according to the first configuration that has been restored, such as:
a. Performing L1 measurements on reference signals (e.g. SSBs and/or CSI-RS) of at least one cell and/or PCI that is not the PCell (or the PCell's PCI), where the PCell is the cell the UE is resuming the connection;
b. Monitoring the reception of lower layer signaling, e.g. MAC CE for indicating L1/L2 centric inter-cell mobility;
c. Monitoring the reception of lower layer signaling, e.g. MAC CE for indicating a TCI state whose QCL source has a RS of another cell that is not the PCell.

In one example, upon restoring the first configuration, the UE determines that the PCell is the cell the UE is in when it initiated the resume procedure. The UE may have stored the configuration of that cell (e.g. ServingCellConfigCommon and/or ServingCellConfig), and if that was considered as a candidate cell it is now considered as the PCell.

At the network side, this may be useful in case the UE resumes in the same cell the UE has been suspended. In that case, the candidate cells and/or PCIs for L1/L2 centric inter-cell mobility remains similar and/or the same.

In one example, the action is performed by the UE if the RRC Resume message contains an indication which indicates the action to be performed.

In one example, the action is performed by the UE if the RRC Resume message has the absence of an indication, where the absence indicates that the action is to be performed. This may be the absence of the fields and/or IEs for configuring L1/L2 centric inter-cell mobility (delta-signaling without additional configurations).

In an example, solution y) is applicable to all cases in steps 130 and 140. For example, for the case the UE has stored the first configuration when it has entered RRC_INACTIVE (i.e. solution b) of step 130 for suspend), the restored configuration (the first configuration) is the basis for applying the second configuration (delta signaling), where the second configuration can be included in the RRC resume message and may be used for at least one of the following:
Modify at least one parameter related to the L1 measurements for L1/L2 centric inter-cell mobility, e.g. L1 measurements for RSs of at least one of the candidate cells;
Modify at least one parameter of one of the candidate cells and/or PCIs configured in the first configuration, e.g. a cell-specific parameter for one of the candidate cells and/or PCIs; that may be a parameter within one of the ServingCellConfigCommon IE instances;
Add at least one parameter of one of the candidate cells and/or PCIs configured in the first configuration;
Remove at least one parameter of one of the candidate cells and/or PCIs configured in the first configuration;
Add a new candidate cell and/or PCI, e.g. a new instance of cell-specific parameters, like a new instance of ServingCellConfigCommon;
Remove one of the candidate cells and/or PCIs in the first configuration;
Modify the configuration of one of the TCI states configured in the first configuration, e.g. change the RS in the QCL source;
Add a new TCI state, in addition to the ones in the first configuration, e.g. a new TCI state whose QCL source has an RS from a new candidate cell also configured in the second configuration, or a cell candidate already present in the first configuration;
Remove one of the TCI states configured in the first configuration;
Modify or add a “part of configuration” associated to a specific PCI as defined as an alternative. As these “parts of configurations” may have been indexed according to how many different PCI/SSB the UE is configured with, the index may be used as an indication for which parts to add or modify.

The second configuration may contain similar type of parameters (possibly with different values) as the first configuration. For example, it may contain the configurations of candidate cells and/or candidate PCI for L1/L2 centric inter-cell mobility.

the second configuration can be a delta configuration, meaning that only the parameters that are changed (from the first configuration) are indicated and signaled.

The second configuration may be included in the IE CellGroupConfig for the MCG.

In an example, solution y) is also applicable for the case the UE has deleted the first configuration when it has entered RRC_INACTIVE (e.g. step 130 solution a)) or in response to determining to resume the connection (e.g. step 140 solution 2)).

In an example, in cases where the UE has stored or restored the first configuration (e.g. solution b) of step 130 or solution 1) of step 140), the UE deletes/releases/discards the first configuration upon receiving an RRC Resume message.

In one example, the UE deletes/releases/discards the first configuration upon receiving an RRC Resume message including an indication, indicating that the UE shall perform this deletion.

In another example, the UE may delete/release/discard a “part of a configuration” associated to a specific PCI/SSB.

The method above describes that the UE receives a first configuration, then the connection is suspended and later resumes. However, some of the steps do not necessarily require the UE to have received the first configuration. For example, the UE may have been suspended without having been configured with the first configuration. Then, when the UE resumes, the UE could anyways according to the method receive an RRCResume message including a configuration (e.g. the second configuration).

It should be noted that the above method (100) can also apply to an inter-cell mTRP configuration.

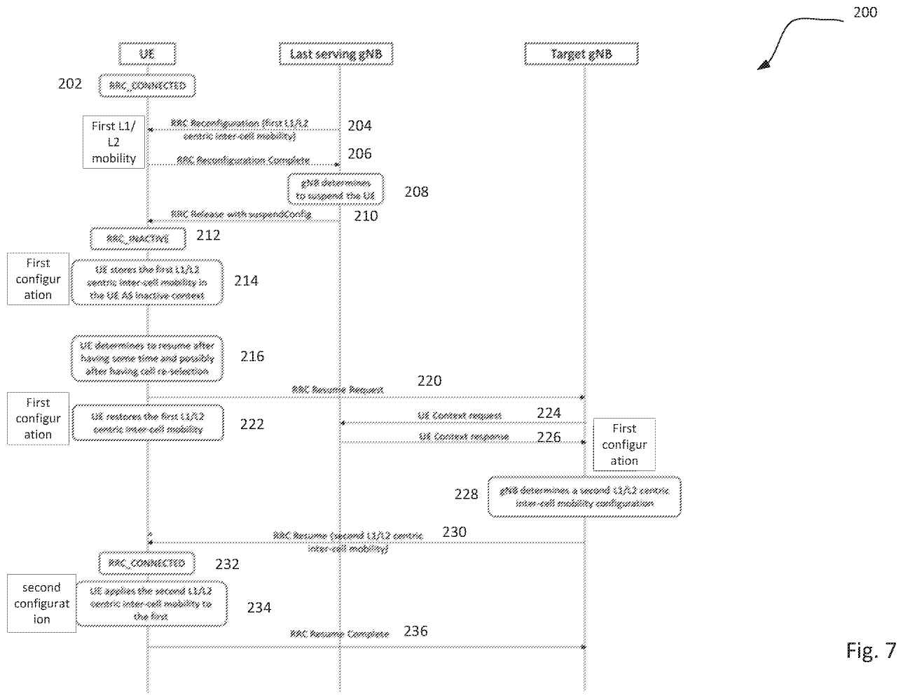

An example of the above steps of method 100 is illustrated in the signaling flow of FIG. 7 between a UE, a last serving gNB and a target gNB.

In step 202, the UE is in the RRC_connected state. In step 204, the UE receives a RRC reconfiguration message with a first configuration (e.g. for L1/L2 centric inter-cell mobility or mTRP operation) from the serving gNB (which will be referred to as the last serving gNB in the context of suspending and resuming a connection). At this point, the UE is configured with the first configuration. In step 206, the UE responds back to the gNB with a RRC reconfiguration complete message. In step 208, the gNB determines to suspend the connection with the UE for some reasons. So, in step 210, the gNB sends a RRCrelease with suspendConfig to the UE. In step 212, the UE enters in RRC_Inactive in response to receiving the release message. In 214, the UE stores the first configuration in the UE AS Inactive context. In step 216, the UE determines to resume the connection after some time and possibly after having done a cell re-selection (of a new cell that may be served by another gNB, e.g. the target gNB). In step 220, the UE sends a RRC Resume Request to the target gNB. In step 222, the UE restores the first configuration. In step 224, the target gNB sends a request to the last serving gNB for the UE context. In step 226, the last serving gNB provides the UE context in a response to the target gNB. In step 228, the target gNB determines a second configuration (e.g. for L1/L2 centric inter-cell mobility). In step 230, the target gNB sends a RRC Resume message to the UE; the resume message may comprise the second configuration. In response to receiving this message, the UE enters into RRC_connected state, in step 232. In step 234, the UE applies the second configuration and in step 236, the UE sends a RRC resume complete message to the target gNB.

Furthermore, a method performed by a first network node (it may be a gNB, or within a gNB, e.g. in case of mTRP), operating as the serving network node for a UE, will be now described. The method may comprise:
transmitting a first configuration for L1/L2 centric inter-cell mobility or inter-cell mTRP operation, the first configuration comprising one or multiple parameters;
transmitting a message to the UE for suspending the connection and indicating the UE to transition to Inactive state;
performing at least one of the actions with the first configuration, responsive to the transmission of the message from the first network node to suspend the connection:
   a. Solution a) deleting/releasing/discarding the first configuration;
   b. Solution b) storing the first configuration;
receiving a request for the UE's context from a second network node and providing the UE context to the second network node.

Another method performed by a second network node (it may be a gNB or within a gNB, e.g. in case of mTRP), operating as the target network node for a UE, may comprise:

receiving an RRC Resume Request message; performing the context fetching with the first network node (e.g. last serving gNB) based on the Inactive-Radio Network Temporary Identifier (I-RNTI) that the UE included in the RRC resume Request;
transmitting an RRC Resume message; entering RRC_CONNECTED, and performing one of the following actions related to inter-cell mTRP operation or L1/L2 centric inter-cell mobility:
   a. Solution x) restore a first configuration for inter-cell mTRP operation or L1/L2 centric inter-cell mobility, that was stored in the UE context, and resume the operation according to the first configuration (possibly upon reception of the RRC Resume Complete from the UE);
   b. Solution y) including a second configuration for inter-cell mTRP operation or L1/L2 centric inter-cell mobility in the RRC Resume message, and applying the second configuration as it is or on top of the first configuration (possibly upon reception of the RRC Resume Complete from the UE);
   c. Solution z) deleting/releasing/discarding the first configuration.

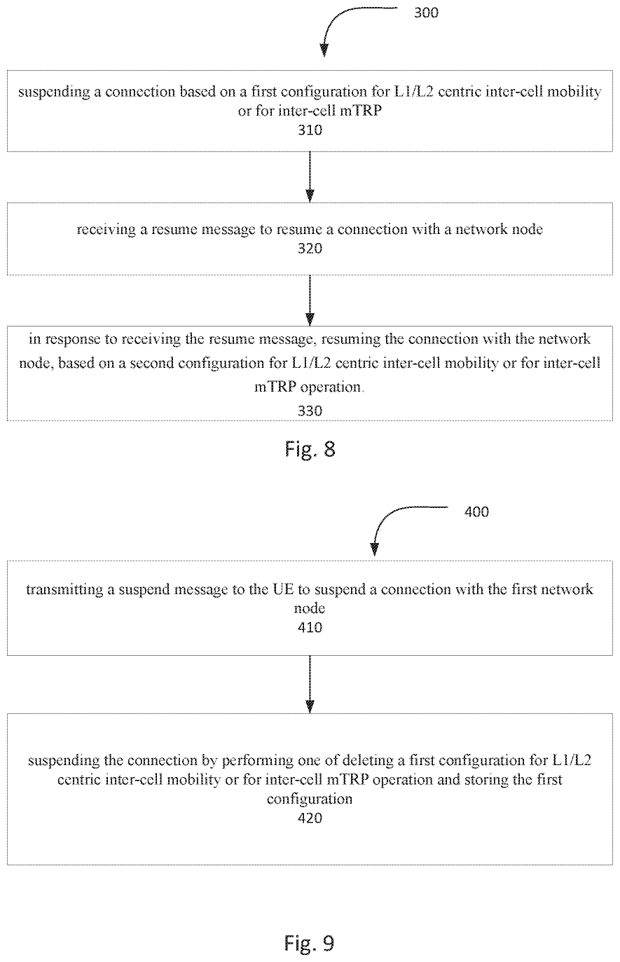

Based on the above methods, FIG. 8 illustrates a flow chart of a method 300 in a wireless device or UE for handling suspend-resume of a connection in the context of L1/L2 centric inter-cell mobility and/or inter-cell mTRP. Method 300 may comprise:

Step 310: suspending a connection based on a first configuration for L1/L2 centric inter-cell mobility or for inter-cell mTRP;

Step 320: receiving a resume message to resume a connection with a network node;

Step 330: in response to receiving the resume message, resuming the connection with the network node, based on a second configuration for L1/L2 centric inter-cell mobility or for inter-cell mTRP operation.

In some examples, resuming the connection may comprise transitioning from an inactive state to a connected state.

In some examples, further comprising, prior to suspending the connection, the UE may receive a suspend message to suspend the connection with the network node.

In some examples, suspending the connection may comprise transitioning to an inactive state.

In some examples, the UE may receive the first configuration, prior to receiving the suspend message.

In some examples, in response to receiving the suspend message, the UE may store the first configuration. In some examples, in response to determining to resume the connection, the UE may restore the stored first configuration.

In some examples, the first configuration is the same as the second configuration. In this case, resuming the connection with the network node, based on the second configuration for L1/L2 centric inter-cell mobility or for inter-cell mTRP operation may comprise resuming the connection according to the first configuration. In some examples, resuming the connection with the network node, based on the second configuration for L1/L2 centric inter-cell mobility or for inter-cell mTRP operation may comprise resuming the connection and deleting the first configuration.

In some examples, the UE may receive the second configuration. In this case, resuming the connection with the network node, based on the second configuration for L1/L2 centric inter-cell mobility or for inter-cell mTRP operation may comprise resuming the connection by applying the second configuration.

In some examples, the second configuration may be received in the RRC resume message.

In some examples, the second configuration may be a delta configuration compared to the first configuration.

In some examples, resuming the connection with the network node, based on the second configuration for L1/L2 centric inter-cell mobility or for inter-cell mTRP operation may comprise resuming the connection by applying the first configuration and the second configuration.

In some examples, in response to receiving the suspend message, the UE may delete the first configuration.

In some examples, in response to determining to resume the connection, the UE may delete the stored first configuration.

In some examples, the first configuration and the second configuration may comprise one or more parameters.

In some examples, the one or more parameters may comprise cell-specific parameters, wherein the cell-specific parameters are configured for each target candidate cell for L1/L2 centric inter-cell mobility.

In some examples, the one or more parameters may comprise PCI-specific parameters, wherein the PCI-specific parameters are configured for each target PCI candidate for L1/L2 centric inter-cell mobility.

Some further examples of the one or more parameters are given in the sections above entitled “L1/L2 centric (inter-cell) mobility signaling alternatives” and “Inter-cell mTRP.

In some examples, the first configuration or second configuration may be for a MCG, a SCG or both the MCG and SCG.

In some examples, deleting the first configuration may be further in response to receiving an indication from the network node to discard the first configuration to avoid configuration mismatch between the network node and the UE.

In some examples, deleting the first configuration may comprise deleting at least a subset of parameters for one of candidate cells.

In some examples, storing the first configuration may comprise storing at least a subset of parameters for at least one candidate cell.

In some examples, the first configuration may be stored in a UE AS inactive context.

In some examples, restoring the first configuration may comprise restoring a field and/or an IE stored in a UE AS inactive context.

In some examples, resuming an operation may comprise performing measurement on reference signals of at least one cell and/or PCI that is not the Pcell.

In some examples, applying the delta configuration may comprises modifying (e.g. removing/adding) at least one parameter related to L1 measurements for L1/L2 centric inter-cell mobility.

In some examples, applying the delta configuration may comprise modifying (e.g. removing/adding) at least one parameter of one of candidate cells and/or PCIs configured for the first configuration.

In some examples, releasing/deleting the first configuration may comprise releasing (deleting/discarding) a part of a configuration associated to a specific PCI/SSB.

Now, turning to FIG. 9, a flow chart of a method 400 by a first network node (gNB) for handling suspend-resume of a connection in the context of L1/L2 centric inter-cell mobility and/or inter-cell mTRP will be described. Method 400 may comprise:

Step 410: transmitting a suspend message to the UE to suspend a connection with the first network node; and

Step 420: suspending the connection by performing one of deleting a first configuration for L1/L2 centric inter-cell mobility or for inter-cell mTRP operation and storing the first configuration.

In some examples, the first network node may transmit the first configuration to the UE, prior to transmitting the suspend message.

In some examples, the first configuration may comprise one or more parameters.

In some examples, the one or more parameters comprise cell-specific parameters or PCI-specific parameters.

In some examples, the first network node may receive a request for a UE context from a second network node and providing the UE context to the second network node.

In some examples, the first network node may receive a resume request message from the UE.

In some examples, the first network node may send a resume message to the UE.

In some examples, in response to sending the resume message, the first network node may restore the first configuration if it was stored and resume the connection according to the first configuration.

In some examples, the resume message may comprise a second configuration for L1/L2 centric inter-cell mobility or for inter-cell mTRP operation and wherein resuming the connection may comprise applying the second configuration.

In some examples, the resume message may comprise a second configuration for L1/L2 centric inter-cell mobility or for inter-cell mTRP operation and wherein resuming the connection may comprise applying the second configuration on top of the first configuration.

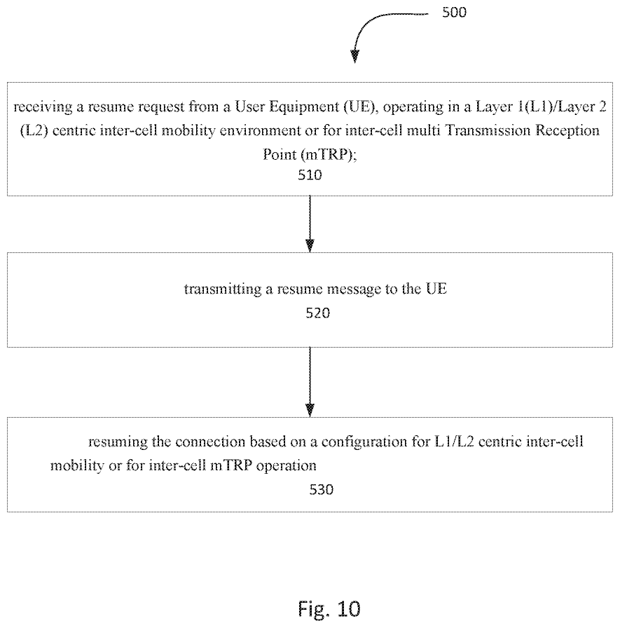

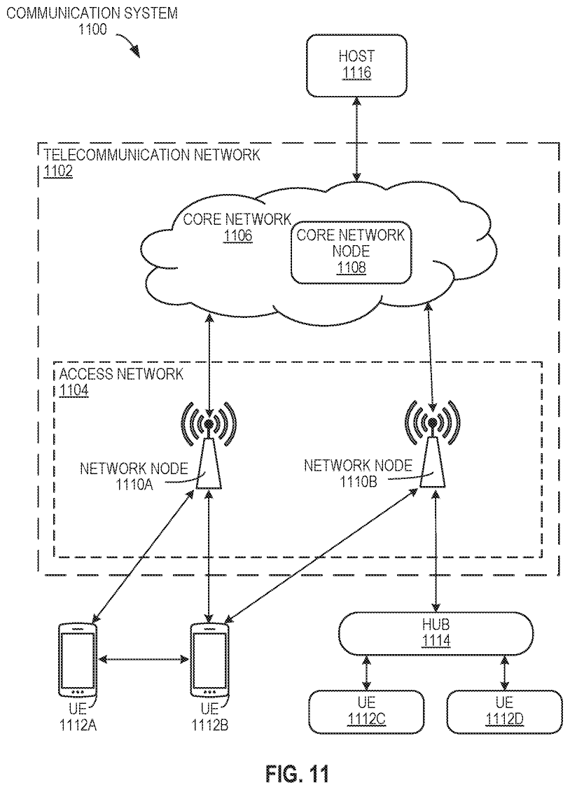

FIG. 10 illustrates a flow chart of a method 500 by a second network node (gNB) for handling suspend-resume of a connection in the context of L1/L2 centric inter-cell mobility and/or inter-cell mTRP. Method 500 may comprise:

Step 510: receiving a resume request from a UE, operating in a L1/L2 centric inter-cell mobility environment or for inter-cell mTRP;

Step 520: transmitting a resume message to the UE; and

Step 530: resuming the connection based on a configuration for L1/L2 centric inter-cell mobility or for inter-cell mTRP operation.

In some examples, the second network node may send a request to a first network node for a UE context.

In some examples, the second network node may receive the UE context, the UE context comprising the configuration.

In some examples, resuming the connection based on the configuration may comprise restoring the configuration and resuming the connection according to the restored configuration.

In some examples, the resume message may comprise the configuration for L1/L2 centric inter-cell mobility or for inter-cell mTRP operation.

In some examples, resuming the connection may comprise applying the configuration to the resumed connection.

In some examples, resuming the connection may comprise applying the configuration to the resumed connection on top of another configuration for L1/L2 centric inter-cell mobility or for inter-cell mTRP operation.

In some examples, the second network node may delete the configuration.

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

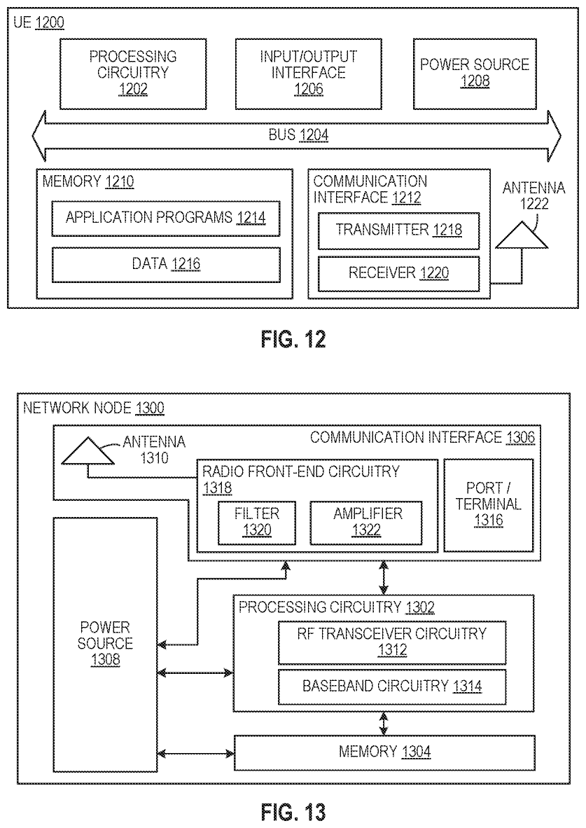

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Some UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs). The processing circuitry 1202 is configured to perform any of the steps of methods 100 and 200 of FIGS. 6 and 8 respectively.

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable ROM (PROM), erasable programmable ROM (EPROM), electrically erasable programmable ROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, NR, UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic, random (e.g., to even out the load from reporting from several sensors), in response to a triggering event, in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, and any kind of medical device, like a heart rate monitor or a remote controlled surgical robot, etc. A UE in the form of an IoT device comprises circuitry and/or software in dependence of the intended application of the IoT device in addition to other components as described in relation to the UE 1200 shown in FIG. 12.

As another example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NBs. In such a scenario, each unique NB and RNC pair, may in some instances be considered a single separate network node. In some embodiments, the network node 1300 may be configured to support multiple RATs. In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. The radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units. The processing circuitry 1302 may be configured to perform any of the steps of methods 300 and 400 of FIGS. 9 and 10 respectively.

The memory 1304 may comprise any form of volatile or non-volatile computer-readable memory including, without limitation, persistent storage, solid-state memory, remotely mounted memory, magnetic media, optical media, RAM, ROM, mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

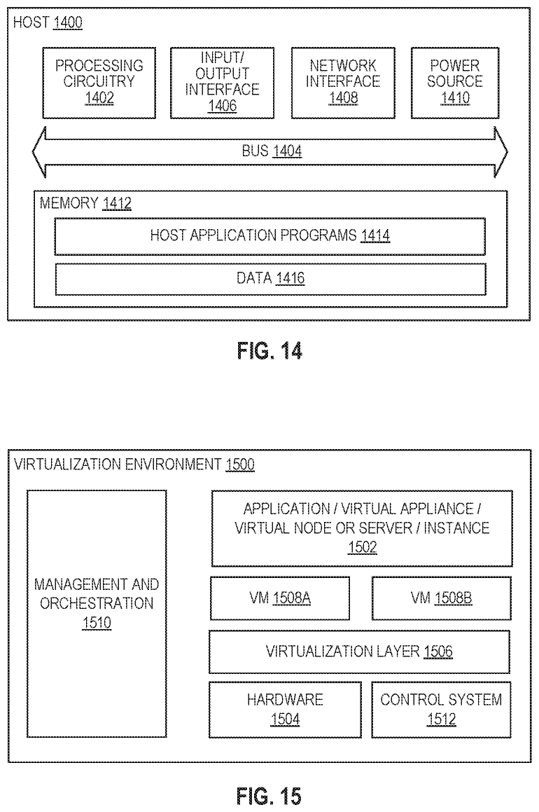

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

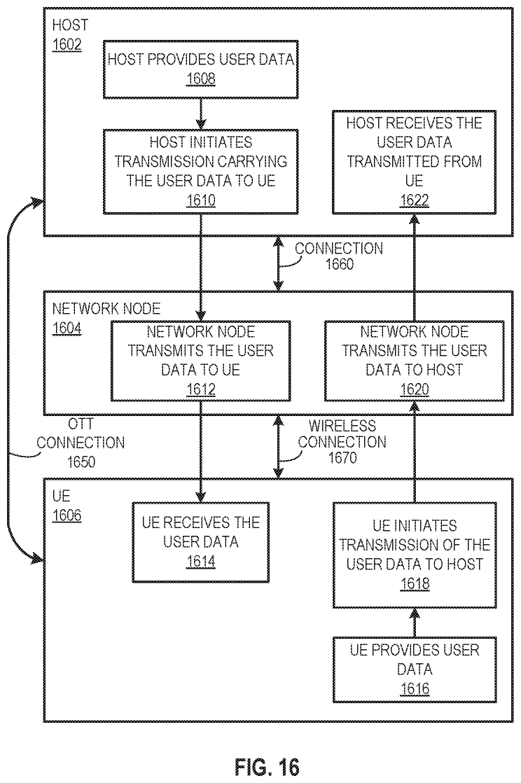

FIG. 16 shows a communication diagram of a host 1602 communicating via a network node 1604 with a UE 1606 over a partially wireless connection according to some embodiments. Example implementations of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, e.g. one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some examples, the user data is associated with a particular human user interacting with the UE 1606. In other examples, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, according to the teachings of the embodiments described herein. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve e.g., the data rate, latency, power consumption and thereby provide benefits such as, e.g., reduced user waiting time, improved content resolution, better responsiveness, extended battery lifetime.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some examples, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, e.g., empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The above-described embodiments are intended to be examples only. Alterations, modifications and variations may be effected to the particular embodiments by those of skill in the art without departing from the scope of the description, which is defined solely by the appended claims.

1. A method performed by a user equipment (UE), the method comprising:
receiving a configuration for Layer (L1)/Layer 2 (L2) centric inter-cell mobility;
receiving a suspend message to suspend a connection with a network node;
suspending the connection; and
in response to receiving the suspend message, deleting the configuration for the L1/L2 centric inter-cell mobility.

2. (canceled)

3. (canceled)

4. The method of claim 1, wherein suspending the connection comprises transitioning to an inactive state.

5. (canceled)

6. The method of claim 1, further comprising, in response to receiving the suspend message, storing the first configuration.

7-16. (canceled)

17. The method of claim 6, further comprising, in response to determining to resume the connection, deleting the stored configuration.

18. The method of claim 1, wherein the configuration comprises one or more parameters.

19. The method of claim 18, wherein the one or more parameters comprise cell-specific parameters, wherein the cell-specific parameters are configured for each target candidate cell for L1/L2 centric inter-cell mobility.

20. The method of claim 18, wherein the one or more parameters comprise Physical Cell Identity (PCI)-specific parameters, wherein the PCI-specific parameters are configured for each target PCI candidate for L1/L2 centric inter-cell mobility.

21. The method of claim 18, wherein the configuration is for a Master Cell Group (MCG), a Secondary Cell Group (SCG) or both the MCG and SCG.

22. The method of claim 16, wherein deleting the configuration is further in response to receiving an indication from the network node to discard the configuration to avoid configuration mismatch between the network node and the UE.

23. The method of claim 1, wherein deleting the configuration comprises deleting at least a subset of parameters for one of candidate cells.

24. The method of claim 6, wherein storing the configuration comprises storing at least a subset of parameters for at least one candidate cell.

25. (canceled)

26. (canceled)

27. A user equipment (UE) comprising processing circuitry and network interfaces connected thereto, the processing circuitry configured to:
receive a configuration for Layer (L1)/Layer 2 (L2) centric inter-cell mobility;
receive a suspend message to suspend a connection with a network node;
suspend the connection; and
in response to receiving the suspend message, delete the configuration for the L1/L2 centric inter-cell mobility.

28. A method performed by a first network node which is in communication with a user equipment (UE), the method comprising:
transmitting a configuration for a Layer 1 (L1)/Layer 2 (L2) centric inter-cell mobility to the UE;
transmitting a suspend message to the UE to suspend a connection with the first network node; and
suspending the connection by deleting the configuration for L1/L2 centric inter-cell mobility.

29. (canceled)

30. The method of claim 28, wherein the first configuration comprises one or more parameters.

31. The method of claim 30, wherein the one or more parameters comprise cell-specific parameters or Physical Cell Identity (PCI)-specific parameters.

32. The method of claim 28, further comprising receiving a request for a UE context from a second network node and providing the UE context to the second network node.

33-46. (canceled)

47. The method of claim 1, further comprising, in response to receiving the suspend message, before entering RRC_INACTIVE, deleting the configuration for L1/L2 centric inter-cell mobility.

48. The UE of claim 27, wherein the configuration comprises one or more parameters, the one or more parameters comprising cell-specific parameters, wherein the cell-specific parameters are configured for each target candidate cell for L1/L2 centric inter-cell mobility.

49. The UE of claim 27, wherein the configuration comprises one or more parameters, the one or more parameters comprising Physical Cell Identity (PCI)-specific parameters, wherein the PCI-specific parameters are configured for each target PCI candidate for L1/L2 centric inter-cell mobility.

50. The UE of claim 27, wherein the configuration is for a Master Cell Group (MCG), a Secondary Cell Group (SCG) or both the MCG and SCG.
